(19) United States
(12) Patent Application Publication
(10) Pub. No.: US 2015/0285450 A1
(43) Pub. Date: Oct. 8, 2015

(54) Lighting device for indirect illumination

(71) Applicant: KONINKLIJKE PHILIPS N.V., Eindhoven (NL)

(72) Inventors: Hendrikus Hubertus Petrus Gommans, Eindhoven (NL); Marcellinus Petrus Carolus Michael Krijn, Eindhoven (NL); Fetze Pijlman, Eindhoven (NL)

(73) Assignee: KONINKLIJKE PHILIPS N.V., Eindhoven (NL)

(21) Appl. No.: 14/437,018

(22) PCT Filed: Oct. 1, 2013
(86) PCT No.: PCT/IB13/59036

§ 371 Date: Apr. 20, 2015

Related U.S. Application Data
(60) Provisional application No. 61/715,895, filed on Oct. 19, 2012.

(51) Int. Cl. F21S 8/06; F21V 5/02; F21V 7/00

(52) U.S. Cl. CPC F21S 8/06; F21V 7/0091; F21V 5/02; F21Y 2103/003

(57) ABSTRACT

According to an aspect of the invention, a lighting device (100) for illuminating a secondary surface (200), thereby providing indirect illumination via reflection from the illuminated secondary surface is provided. The lighting device comprises a light source, a collimator arranged to collimate light from the light source, and redirecting means (120) arranged to redirect at least a portion of the collimated light into a range of directions towards the secondary surface. The intensity of redirected light increases with the angle of the direction of the redirected light relative to a normal to the secondary surface from a first intensity value to a second intensity value. The ratio of the second intensity value to the first intensity value is between 25 and 400. The present invention uses the concept of shaping the light intensity distribution of the lighting device in order to increase the possible illumination area of the lighting device.

### FIELD OF THE INVENTION

The present invention generally relates to the field of lighting devices for indirect illumination.

### BACKGROUND OF THE INVENTION

Indirect illumination is normally used as general illumination in offices and the like spaces. Indirect illumination is achieved by illuminating a secondary surface (such as a ceiling or wall), thereby providing reflection of light from the secondary surface towards an object (or space) to be illuminated. In conventional lighting systems, fluorescent lamp tubes in reflecting housings are used to create indirect illumination. However, such fluorescent lamp tubes are currently being replaced by more energy efficient solid state based alternatives, such as light emitting diode (LED) based lighting devices. WO-2011051925 shows a LED-based lighting device for indirect illumination. The lighting device comprises LEDs and a diffuse reflector for reflecting the light from the LEDs towards a ceiling.

### SUMMARY OF THE INVENTION

It is an object of the present invention to provide a lighting device able to illuminate a region which is larger than that obtained by prior art lighting devices. It is also an object of the present invention to provide a lighting device able to more uniformly illuminate a secondary surface.

These and other objects are achieved by means of a lighting device as defined by the independent claim. Preferred embodiments are defined by the dependent claims.

According to an aspect of the invention, a lighting device for illuminating a secondary surface, thereby providing indirect illumination via reflection from the illuminated secondary surface is provided. The lighting device comprises a light source, a collimator arranged to collimate light from the light source, and redirecting means arranged to redirect at least a portion of the collimated light into a range of directions towards the secondary surface. The light source, the collimator and the redirecting means are arranged such that the intensity of redirected light increases with the angle of the direction of the redirected light relative to a normal to the secondary surface from a first intensity value to a second intensity value. The ratio of the second intensity value to the first intensity value is between 25 and 400.

The inventors have realized that the size of an area of a secondary surface (e.g. a ceiling or wall) illuminated by a lighting device determines the number of lighting devices for indirectly illuminating a specific region. In general, it would be desirable to provide a lighting device able to illuminate a larger area of a secondary surface so as to reduce the number of lighting devices required to indirectly illuminate a specific region. The present invention uses the concept of shaping the light intensity distribution of the lighting device in order to increase the achievable illumination area of the lighting device. As the second intensity value is 25 to 400 times higher than the first intensity value, the lighting device may be arranged to illuminate a larger area (e.g. of a secondary surface) from a closer distance to the area while still providing an enhanced uniformity of the illumination of the secondary surface. For providing an enhanced uniformity of the illumination of the secondary surface as well as an increased illumination coverage (larger illumination area), the light emitted in directions forming a larger angle with the normal to the secondary surface may have a higher intensity compared to the light emitted in directions forming a lower angle with the normal to the secondary surface. The larger illumination area reduces the number of lighting devices required to illuminate a specific area.

Further, the use of a light source, collimator and redirecting means allows to more accurately define (or shape) the output of the lighting device. By collimating the light, the light from the light source may be projected on the redirecting means, whereby the direction of the light impinging at the redirecting means is more predictable. The light intensity distribution may then be shaped as desired by defining the beam shaping characteristics of the redirecting means. The beam shaping characteristics is the characteristics of an optical element influencing the direction and shape of a light beam passing the optical element.

It will be appreciated that the secondary surface is not a part of the lighting device, but will cooperate with the lighting device when the lighting device is installed (and in use) in order to create indirect illumination. Further, it will be appreciated that, in the present specification, the light directions and the location of the lighting device defined relative to the secondary surface are applicable when the lighting device is installed (and in use).

According to an embodiment, the degree of collimation provided by the collimator in combination with the beam shaping characteristics of the redirecting means may be configured such that the intensity of the redirected light increases with the angle of the direction of the redirected light relative to the normal to the secondary surface from the first intensity value to the second intensity value. The collimator may provide a particular light intensity distribution, which is further shaped and redirected by the beam shaping characteristics of the redirecting means. The degree of collimation is a measure representative of the angular beam spread obtained by the collimator and is normally expressed as a full width half max (FWHM).

According to an embodiment, the light source, the collimator and the redirecting means may be arranged such that light redirected in a direction pointing at the centre (or mid) portion of an illumination area of the lighting device has a third intensity value. The ratio of the third intensity value to the first intensity value may be between 3 and 4, which is advantageous in that it further enhances the uniformity of the illumination of the secondary surface and thereby an enhanced uniformity of the light provided by the lighting device.

For example, the lighting device may be adapted to be mounted at a first distance from the secondary surface such that the redirected light impinges at the secondary surface up to a second distance (along the secondary surface) from the lighting device. Further, the light source, the collimator and the redirecting means may be arranged such that the light redirected for impinging at the secondary surface at half the second distance from the lighting device has the third intensity value.

In an embodiment, the ratio of the second distance to the first distance may be at least 5, preferably at least 7, and most preferably at least 10. A larger ratio of the second distance to the first distance means that the lighting device may be mounted closer to the secondary surface for a specific illumination area of the secondary surface. Alternatively, it means that the illumination area of the lighting device may be increased for a specific mounting distance to the secondary surface. As the ratio of the second intensity value to the first intensity value is between 25 and 400, it is possible to have the ratio of the second distance to the first distance as defined above while still providing an enhanced uniformity of the illumination of the secondary surface.

According to an embodiment, the range of directions (of the redirected light) may define an angle interval (or beam spread) of at least 30 degrees to 60 degrees, preferably at least 20 degrees to 70 degrees, and even more preferably at least 10 degrees to 80 degrees. A wider beam spread provides a larger illumination area. As the ratio of the second intensity value to the first intensity value is between 25 and 400, it is possible to have such a beam spread while still providing an enhanced uniformity of the illumination of the secondary surface.

In an embodiment, the light source, the collimator and the redirecting means may be arranged such that at least 50% of the luminous flux of the redirected light originates from directions forming an angle exceeding 45 degrees, preferably exceeding 55 degrees and most preferably exceeding 70 degrees relative to the normal to the secondary surface, thereby enabling a larger coverage of the illumination area of the lighting device with an enhanced illumination uniformity.

According to an embodiment, the light source, the collimator and the redirecting means may be arranged such that the intensity, I, of the redirected light increases from the first intensity value to the second intensity value with (i.e. as a function of) the angle, θ, of the direction of the redirected light relative to the normal to the secondary surface according to the equation:

I(θ)=cos⁻²(θ)±D (Equation 1)

wherein D is a deviation ranging from 0 to 20% of the maximum intensity, Iₘₐₓ, of the redirected light. The present embodiment is advantageous in that the uniformity of the illumination of the secondary surface is further enhanced, as the light intensity is more accurately defined across the range of emission directions. Preferably, the deviation may range from 0 to 15%, such as 0 to 10% or 0 to 5%, of the maximum intensity, Iₘₐₓ, of the redirected light.

In an embodiment, the redirecting means may comprise a specular reflective surface, thereby enabling a more accurate shaping of the light distribution output by the reflective surface. A specular reflective surface reflects light in a more predictable way as compared to a diffuse reflective surface.

According to an embodiment, the light source may be a linear light source and the redirecting means may present an elongated body whose longitudinal direction extends along the longitudinal direction of the linear light source, which is advantageous in that the lighting device may be used to replace a traditional fluorescent lamp tube.

According to another embodiment, the redirecting means may have an annular shape and one or more light sources and one or more collimators are arranged at a centre portion (or in the middle) of the annular shape, thereby providing an annular (circular) illumination area.

In an embodiment, the light source and the collimator may be arranged such that the average direction of the light collimated by the collimator is directed along the secondary surface, and the redirecting means may comprise a convex reflective surface being arranged to face the collimator and the secondary surface. In other words, the light collimated by the collimator propagates mainly (or in average) along the secondary surface. Hence, light is emitted by the light source and then collimated into directions along (e.g. substantially parallel to) the secondary surface. At least a portion of the collimated light then impinges at the convex reflective surface facing the collimator and is reflected into a range of directions towards the secondary surface.

In an embodiment, the light source, the collimator and the reflective surface may be arranged such that the intensity of light reflected by the reflective surface decreases for an increase of the angle of the direction of the light relative to the reflective surface from the second intensity value to the first intensity value. Hence, light reflected into directions having higher angles relative to the reflective surface may impinge at the secondary surface with a higher angle relative to a normal to the secondary surface, i.e. further away from the lighting device when it is installed at the secondary surface, as compared to light reflected into directions having lower angles relative to the reflective surface, which light impinges at the secondary surface with a lower angle relative to the normal to the secondary surface, i.e. closer to the lighting device.

According to an embodiment, the light source may comprise a plurality of light emitting elements arranged in groups, wherein the groups may be arranged to illuminate different portions of the reflective surface via the collimator and be individually controllable with respect to light intensity. The present embodiment is advantageous in that the light intensity distribution of the lighting device may be tuned for adapting the light intensity distribution to a particular installation of the lighting device, such as with respect to the shape of the secondary surface, the mounting distance between the lighting device and the secondary surface and the orientation of the lighting device with respect to the secondary surface. In particular, the groups of light emitting elements may be arranged to illuminate different portions of the reflective surface such that they produce different solid angles of reflected light. Hence, the different solid angles of light may be individually controlled with respect to light intensity.

According to another embodiment of the present invention, the light source and the collimator may be arranged such that the average direction of the light collimated by the collimator is directed transverse (such as substantially perpendicular) to the secondary surface, and redirecting means may comprise a concave reflective surface arranged to face away from the secondary surface. In other words, the light collimated by the collimator propagates in average transverse to the secondary surface. Hence, light is emitted by the light source and then collimated into directions transverse to the secondary surface. At least a portion of the collimated light then impinges at the concave reflective surface, which preferably faces the light source and faces away from the secondary surface, and is reflected into a range of directions towards the secondary surface. Further, the reflective surface and the collimator may be included in a solid light transmissive optical body. The optical body may have a refractive index adapted to collimate light from the light source entering the optical body (thereby providing the collimator) and to reflect the collimated light at the optical body/air interface by total internal reflection, TIR, (thereby providing the reflective surface). The present embodiment is advantageous in that the collimator and the reflector may be comprised in a single optical body, thereby reducing the number of components in the lighting device, which facilitates manufacturing as well as recycling.

In an embodiment, the redirecting means may further comprise a plurality of prism elements for redirecting light from the concave reflective surface by means of total internal reflection and/or refraction. With prism elements a portion of the light reflected by the reflective surface is redirected into directions other than the light outputted without passing the prism elements (e.g. more towards the secondary surface), thereby widening the light intensity distribution of the lighting device and increasing the area illuminated by the lighting device.

In an embodiment, the collimator and the concave reflective surface may be arranged such that the intensity of light reflected by the reflective surface increases for an increase of the angle of the direction of the light relative to the reflective surface from the first intensity value to the second intensity value. Hence, light reflected into directions having lower angles relative to the reflective surface may impinge at the secondary surface with a higher angle relative to a normal to the secondary surface, i.e. further away from the lighting device when it is installed at the secondary surface, as compared to light reflected into directions having higher angles relative to the reflective surface, which light impinges at the secondary surface with a lower angle relative to the normal to the secondary surface, i.e. closer to the lighting device.

It is noted that the invention relates to all possible combinations of features recited in the claims. Further objectives of, features of, and advantages with, the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiments of the invention.

FIG. 1 shows a lighting device according to an embodiment of the present invention.

FIG. 2 is a schematic view of a cross section of the lighting device shown in FIG. 1 installed at a secondary surface.

FIG. 3 is an enlarged view of a reflector of the lighting device shown in FIG. 2.

FIGS. 4 and 5 show diagrams of a light intensity distribution of a lighting device according to an embodiment of the present invention.

FIG. 6 shows a lighting device according to another embodiment of the present invention.

FIG. 7 shows an enlarged view of an exit surface of the lighting device shown in FIG. 6.

FIGS. 8 to 10 show prism elements according to embodiments of the present invention.

All the figures are schematic, not necessarily to scale, and generally only show parts which are necessary in order to elucidate the invention, wherein other parts may be omitted or merely suggested.

### DETAILED DESCRIPTION OF THE EMBODIMENTS

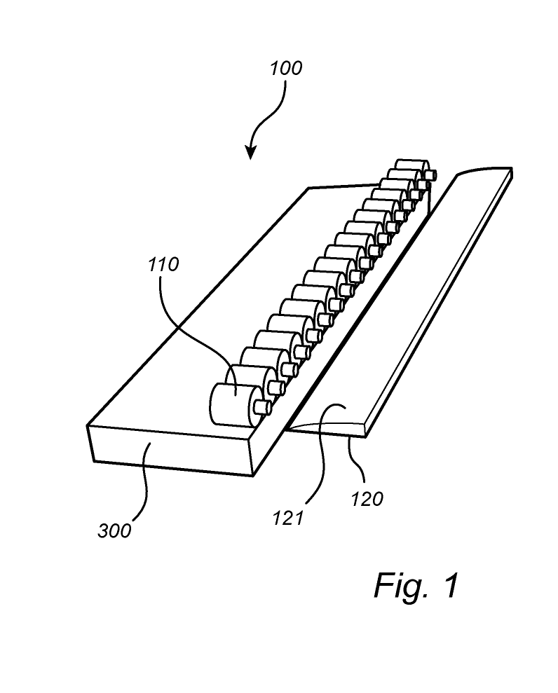

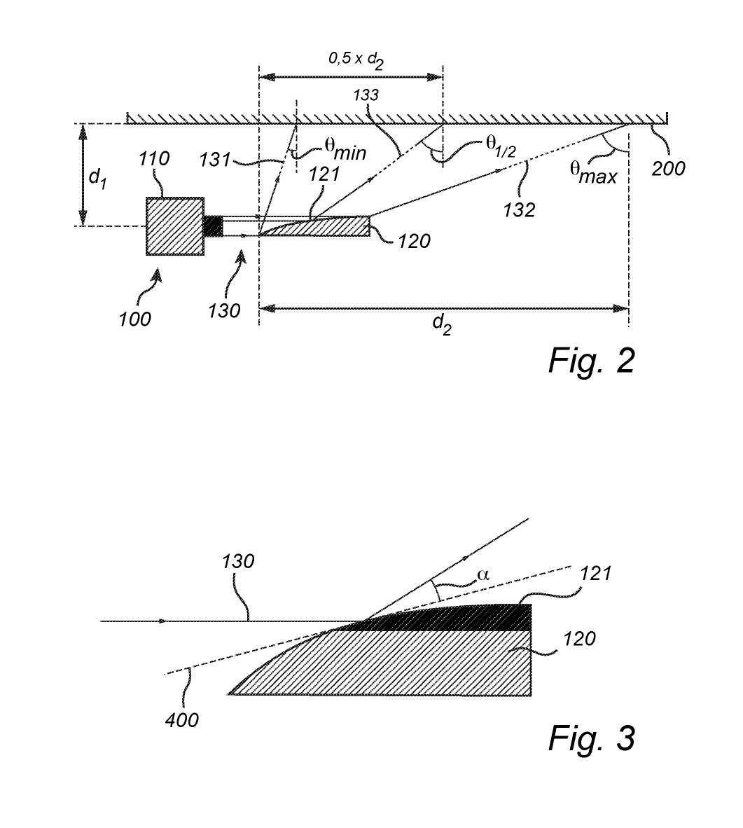

A lighting device according to an embodiment of the present invention will be described with reference to FIGS. 1, 2 and 3. FIG. 1 is a perspective view of a lighting device 100 and FIG. 2 is a cross section of the lighting device 100 when installed to illuminate a secondary surface 200. FIG. 3 is an enlarged view of a reflector of the lighting device 100.

The lighting device 100 is adapted to illuminate the secondary surface 200 for providing reflection from the secondary surface 200, thereby providing indirect illumination of a space or object, such as an office. The secondary surface 200 may e.g. be a ceiling or wall of the space to be indirectly illuminated. The lighting device 100 may be adapted to be mounted to the secondary surface, e.g. as a pendant lamp. The lighting 100 device may therefore be equipped with hanging means or other attachment system (not shown) to hang from the second surface 200.

The size of the area illuminated by the lighting device 100 (herein after referred to as the illumination area) determines the total number of lighting devices required to illuminate a certain region. A larger illumination area obtained by a single lighting device requires fewer lighting devices, which may be more sparsely arranged. Further, in office lighting, it is often desirable to mount the lighting device 100 relatively close to (such as 20-60 cm from) the secondary surface 200 in order to save space. It is also desirable to provide a relatively uniform illumination of the secondary surface 200 in order to provide a relatively uniform indirect illumination of the space. As an illustrative example, if the lighting device 100 is mounted 40 cm from the secondary surface 200 and the illumination area extends 4 m from the lighting device 100, the light emitted in directions having angles between approximately 79 degrees and 84 degrees relative to the normal to the secondary surface 200 impinges at the secondary surface between approximately 2 m to 4 m from the lighting device 100. In other words, the beam direction range of 79 degrees to 84 degrees covers about half of the illumination area. Thus, preferably approximately half the luminous flux may be emitted within this direction range for providing more uniform illumination.

The lighting device 100 comprises one or more light modules 110 (for the sake of simplicity, merely one of the plurality of equally configured light modules shown in FIG. 1 is denoted with reference sign 110), each including a light source and a collimator arranged to collimate light from the light source. The light module 110 may be mounted to a support structure 300. The light module 110 outputs the collimated light, i.e. substantially parallel beams 30. It will be appreciated that the collimated light beams need not be exactly parallel and that some degrees of deviation is expected when using commercially available collimators. Commercially available collimating TIR lenses may e.g. have a FWHM of 6 degrees. The light source may e.g. be a light emitting diode (LED) and the collimator may comprise beam shaping optics, such as a parabolic reflector or a lens. The lighting device 100 further comprises redirecting means in the form of a convex reflector 120 arranged to reflect at least a portion of the collimated light into a range of directions via its redirecting reflective surface 121. The light beam 130 impinging at the reflector 120 is redirected by the redirecting reflective surface 121 into a direction having an angle α relative to (the tangent 400 of) the redirecting reflective surface 121, as shown in FIG. 3. The convex reflective surface 121 of the reflector 120 is arranged to face the light module 110 (or collimator) and the secondary surface 200. The reflector 120 may preferably be a specular reflector and the convex curvature of the reflector 120 may be formed by a smooth convex surface or by facets in the reflective surface 121. The reflector 120 may be an elongated reflector strip with the plurality of light modules 110 located adjacent to one of its elongated sides. Alternatively, the reflector may be an annular reflector with the plurality of light modules located in the middle of the reflector (not shown).

The lighting device 100 may be adapted to be mounted at a first distance (or mounting distance) d₁ from the secondary surface 200 and such that the collimated light outputted from the light module 110 is directed along the secondary surface 200. The first distance d₁ may reach from a centre of the lighting device, such as from the optical axis of the collimator (or light module 110) to the secondary surface 200. The lighting device 100 is arranged to illuminate the secondary surface 200 up to a second distance (or maximum illumination distance) d₂ extending on at least one side of the lighting device 100. Hence, the light reflected by the reflector 120 impinges at the secondary surface 200 up to the second distance d₂, which distance extends along the secondary surface 200 from the lighting device 100. For example, the second distance d₂ may reach from a mid portion of the lighting device, such as from an edge of the reflector 120 facing the light module 110, as shown in FIG. 2. However, the size of the lighting device 100 may be negligible small relative to the size of the illumination area and thereby the second distance d₂. Further, the second distance d₂ may be at least 5, preferably at least 7 and most preferably at least 10 times the first distance d₁. For example, the first distance d₁ may be 40 cm and the second distance d₂ 4 m.

The light module 110 and the convex reflector 120 are arranged such that light is emitted towards the secondary surface 200 over a range of directions, bounded by a first direction 131 which makes a minimum angle θₘᵢₙ relative to the normal to the secondary surface 200, and a second direction 132 which makes a maximum angle θₘₐₓ relative to the normal to the secondary surface 200. The minimum angle θₘᵢₙ may preferably be below 30 degrees or even more preferably below 10 degrees, such as approximately equal to zero, in order to increase the illumination area. Further, the maximum angle θₘₐₓ may be approximately tan⁻¹(d₂/d₁). Light reflected in a third direction 133, pointing at the centre portion of the illumination area, reaches the secondary surface 200 at a distance of 0.5×d₂. This third direction 133 makes a halfway angle θ_{1/2} relative to the normal to the secondary surface 200. The halfway angle θ_{1/2} may be approximately tan⁻¹(d₂/2d₁). The angle θ of the direction of the reflected light relative to the secondary surface 200 increases for a decrease of the angle α of the reflected light relative to the redirecting reflective surface 121.

The light source, the collimator and the reflector 120 are arranged such that the intensity of light reflected by the reflector 120 decreases for an increase of the angle α of the direction of the light relative to the redirecting reflective surface 121 from a second intensity value to a first intensity value. Hence, the degree of collimation provided by the light module 110 in combination with the curvature of the specular reflective convex surface 121 is chosen such that the intensity of the light increases from the first intensity value (which may be a minimum intensity value) for light that is emitted in the first direction 131 up to the second intensity value (which may be a maximum intensity value) for light that is emitted in the second direction 132. Further, the reflection coefficient of the convex reflective surface 121 may be adapted (e.g. by using different deposition techniques) to obtain the desired light intensity distribution of the reflected light. Thus, the intensity of light reflected by the reflector 120 increases with the angle of the direction of the light relative to the normal to the secondary surface 200 from the first intensity value to the second intensity value, whereby a higher light intensity is achieved for light emitted in directions with higher angle relative to the normal to the secondary surface 200 compared to light emitted in directions with lower angle relative to the normal to the secondary surface 200.

The ratio of the second intensity value to the first intensity value is preferably between 25 and 400, such as between 50 and 200, or 75 and 150. For example, if the ratio of the second distance d₂ to the first distance d₁ is 10, the ratio of the second intensity value to the first intensity value may be about 100, in order to provide an enhanced uniformity of the illumination of the secondary surface 200. Furthermore, the ratio of the third intensity value (i.e. the intensity value for light that is emitted in the third direction 133) to the first intensity value may be between 3 and 4. Preferably, the intensity of the emitted light may increase from the first intensity value to the second intensity value with an angular dependency that is approximately equal to 1/cos², thereby further enhancing the uniformity of the light distribution of the lighting device 100. In other words, the light intensity I may vary as a function of the angle θ of the direction of the reflected light relative to the normal to the secondary surface 200 according to Equation 1.

I(θ)=cos⁻²(θ)±D (Equation 1)

D is a deviation ranging from 0 to 20%, such as from 0 to 10%, of the maximum light intensity Iₘₐₓ of the light reflected by the reflector 120.

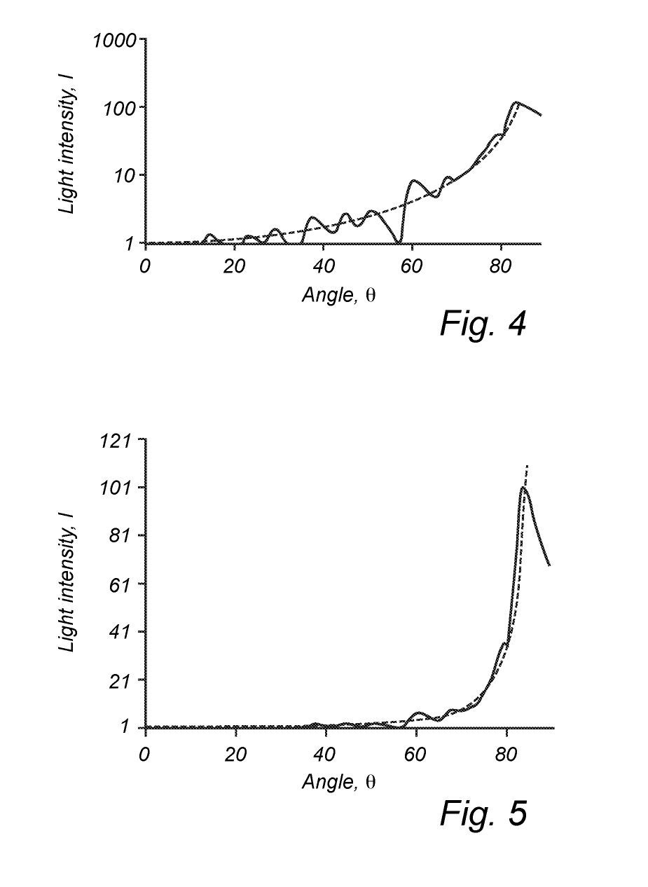

FIG. 4 is a diagram showing the light intensity I emitted by the lighting device 100 on a linear scale in relation to the angle θ of the direction of the emitted light relative to the normal to the secondary surface 200. FIG. 5 is a diagram showing the light intensity I emitted by the lighting device 100 on a logarithmic scale in relation to the angle θ of the direction of the emitted light relative to the normal to the secondary surface 200. In FIGS. 4 and 5, the solid line represents the light intensity distribution of a prototype of a lighting device according to an embodiment of the invention, and the dashed line represents the desired theoretical light intensity distribution. As can be seen, the light intensity distribution of the prototype basically follows the desired theoretical light intensity distribution with some minor deviations only. The deviations are more distinctively illustrated in FIG. 5, as the light intensity I is depicted with a logarithmic scale. Comparison of FIGS. 4 and 5 illustrates the challenge of defining the light intensity distribution at angles θ below 70 degrees, where a small numerical deviation from the desired light intensity distribution gets a rather high impact on the percentage deviation from the desired light intensity distribution.

In an embodiment (not shown), the lighting device may comprise an additional set of a light source, a collimator and a reflector which may be similarly configured as those defined above and oriented to illuminate the secondary surface in an opposite direction (or other way) compared to the other set of a light source, a collimator and a reflector, thereby further increasing (doubling) the illumination area.

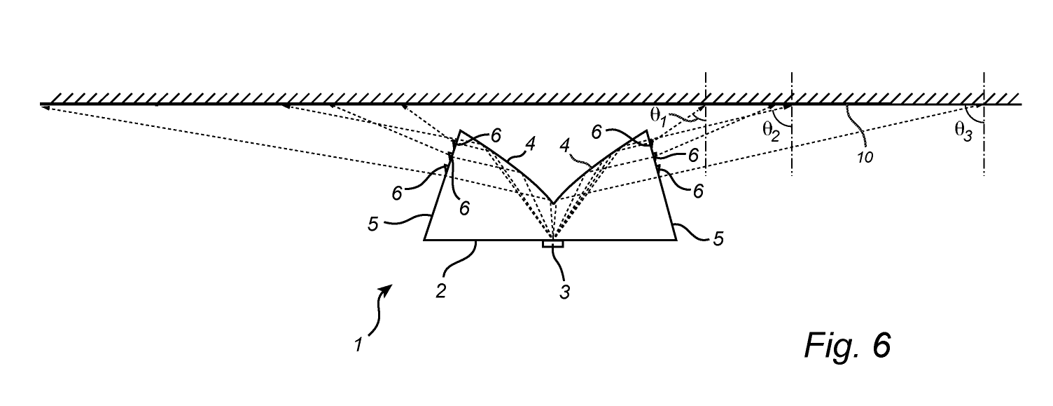

With reference to FIG. 6, another embodiment of the present invention will be described. The lighting device according to the present embodiment comprises an alternative redirecting means for obtaining the above described light intensity distribution including the first, second and third intensity values.

FIG. 6 shows a lighting device 1 being adapted to illuminate a secondary surface 10 for providing reflection from the secondary surface 10, thereby providing indirect illumination of a space or object, such as an office. The lighting device 1 may be adapted to be mounted to the secondary surface 10, e.g. as a pendant lamp. The lighting device 1 may therefore be equipped with hanging means or other attachment system (not shown) to hang from the secondary surface 10. The lighting device 1 comprises at least one light source 3 and an optical structure 2 having an exit surface 5 for outputting light and a redirecting means comprising a reflective surface 4 for reflecting light from the light source 3 towards the exit surface 5. The light source 3 may be a solid state based light source, such as a light emitting diode (LED). The light source 3 may be arranged in abutment to, or at least in proximity to the optical structure 2.

The optical structure 2 (or optical body) may preferably be a solid body made of a light transmissive material, such as transparent plastic or glass. Preferably, the refractive index of the optical structure 2 may be adapted so as to provide a refractive index transition (or junction) at the light source/optical structure interface in case the light source 3 is arranged in abutment to the optical structure 2, or at the air/optical structure interface in case an air gap is present between the light source 3 and the optical structure 2. As the light from the light source 3 enters the optical structure 2, it is refracted into a more narrow beam. Hence, the refractive index transition provides means (or a collimator) for collimating the light from the light source 3. Alternatively, or as a complement, other means for collimating the light from the light source 3 may be used in the lighting device 1, such as a parabolic reflector or a lens (not shown). Preferably, the full width half maximum (FWHM) of the degree of collimation of the collimated light may be comprised within the interval of 60 degrees to 30 degrees and preferably within the interval of 50 degrees to 40 degrees, such as around 42 degrees in order to project a major part of the light from the light source 3 onto the reflective surface 4. With the present embodiment, the light source 3 and the collimating means are arranged such that the average direction of the light collimated by the collimating means is directed transverse to the secondary surface 10.

Further, the refractive index of the optical structure 2 may be adapted so as to obtain total internal reflection (TIR) at the air/optical structure interface at the reflective surface. Hence, light from the light source 3 is reflected at the reflective surface 4 by TIR. Alternatively, or as a complement, the reflective surface may comprise a reflective film or the like for reflecting light from the light source 3. Preferably, the reflective surface 4 may be a specular reflective surface.

The reflective surface 4 may be curved (e.g. concave) and preferably face away from the secondary surface 10 so as to provide a particular light intensity distribution of the reflected light. The degree of collimation provided by the means for collimating light (before it is reflected by the reflective surface 4) in combination with the curvature of the reflective surface 4 may preferably be chosen such that the intensity of the reflected light increases for an increase of the angle of the direction of the reflected light relative to the reflective surface 4. Further, the reflection coefficient of the reflective surface 4 may be adapted (e.g. by using different deposition techniques) to obtain the desired light intensity distribution of the reflected light. Thus, the intensity of light reflected by the reflector 4 increases with the angle of the direction of the light relative to the normal to the secondary surface 10 up to the second intensity value, whereby a higher light intensity is achieved for light emitted in directions with higher angle (such as angle θ₁ illustrated in FIG. 2) relative to the normal to the secondary surface 10 compared to light emitted in directions with lower angle (such as angle θ₂ illustrated in FIG. 2) relative to the normal to the secondary surface 10.

Preferably, the curvature of the reflective surface 4 may be adapted such that the intensity of the reflected light increases with an angular dependency that is approximately equal to 1/cos², thereby further enhancing the uniformity of the light distribution of the lighting device 1. In other words, the light intensity I may vary as a function of the angle θ of the direction of the reflected light relative to the normal to the secondary surface 10 according to Equation 1.

I(θ)=cos⁻²(θ)±D (Equation 1)

D is a deviation ranging from 0 to 20%, such as from 0 to 10%, of the maximum light intensity Iₘₐₓ of the light reflected by the reflective surface 4.

Further, the curved reflective surface 4 may serve to collimate light from the light source 3. Hence, the light from the light source 3 is collimated a second time by the reflective surface 4. Preferably, the FWHM of the degree of collimation of the light collimated by the reflective surface 4 may be less than 15 degrees and preferably less than 10 degrees. Hence, the light beam collimated by the reflective surface 4 may be (at least) almost parallel.

The exit surface 5 may preferably extend in a plane transverse (preferably substantially perpendicular) to the main (or average) direction of the light reflected by the reflective surface 4 in order to reduce refraction of light outputted through the exit surface 5. Hence, in the present embodiment, the exit surface 5 is slightly tilted compared to the normal to the secondary surface.

At the exit surface 5, prism elements 6 are arranged for redirecting a portion of the light reflected by the reflective surface 4. The prism elements 6 are a part of the redirecting means. The prism elements 6 are arranged to complement the light distribution obtained by the light reflected by the reflective surface 4 without passing the prism elements 6, by redirecting light into directions having a lower angle relative to the normal to the secondary surface 10 (e.g. angle θ₃ illustrated in FIG. 2) than the light outputted without passing the prism elements 6. Hence, light redirected by the prism elements 6 will illuminate an area of the secondary surface 10 closer to the lighting device 1 than the area illuminated by light outputted from the exit surface 5 without passing the prism elements 6. Preferably, a major portion of the light redirected by the prism elements 6 is outputted in a range of directions towards the secondary surface 10, which range of directions may define an angle interval relative to a normal to the secondary surface, the angle interval being comprised within the range of 0 degrees to 80 degrees, and preferably within the range of 0 degrees to 75 degrees. Further, a major portion of the light outputted through the exit surface 5 without passing the prism elements 6 may preferably be outputted in a range of directions towards the secondary surface 10, which range of directions may define an angle interval relative to the normal to the secondary surface 10, the angle interval being comprised within the range of 45 degrees to 90 degrees, preferably within the range of 55 degrees to 85 degrees, and even more preferably within the range of 70 degrees to 85 degrees.

Preferably, the intensity of light redirected by the redirecting means (i.e. by the reflective surface 4 and the prism elements 6) increases with the angle of the direction of the light relative to a normal to the secondary surface from a first intensity value to a second intensity value. The ratio of the second intensity value to the first intensity value is between 25 and 400. Hence, the beam shaping characteristic (such as the curvature, reflection coefficient and orientation) of the reflective surface 4 and the beam shaping characteristics (such as the triangular shape and orientation) of the prism elements 6 are selected so as to provide the intensity distribution defined by the first, second (and preferably third) intensity values.

According to an example, the lighting device 1 may be suspended approximately 40 cm from the secondary surface 10 and the illumination area may reach up to 2 m from the lighting device 1. The light outputted from the exit surface 5 without passing the prism elements 6 may then cover one fourth of the illumination area reaching 1.5 m to 2 m away from the lighting device 1, which corresponds to the angular range of 75 degrees to 79 degrees of the outputted light relative to the secondary surface 10. The remaining three forth of the illumination area in terms of angular range is covered by light redirected by the prism elements 6.

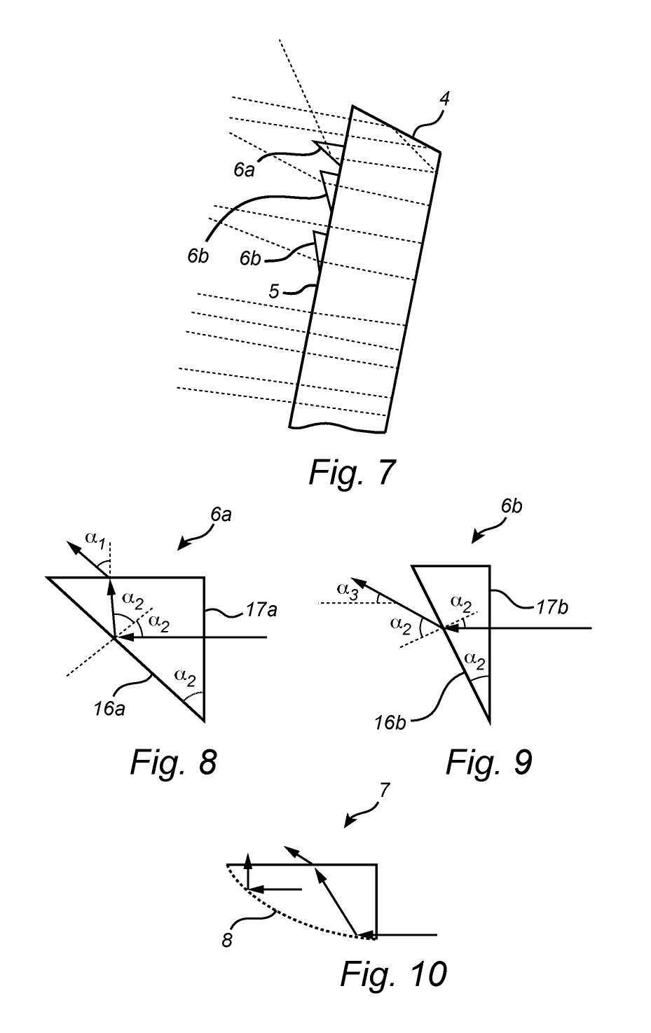

Turning now to FIGS. 7 to 10, embodiments of the prism elements will be described in more detail.

FIG. 7 is an enlarged view of the exit surface 5 of the optical structure 4 illustrating the optical path of light outputted by the lighting device 1. The light outputted through the prism elements 6a, 6b is refracted and/or reflected towards the secondary surface. The prism elements 6a, 6b has a triangular shape and comprise a base 17a, 17b making optical contact with the exit surface 5, and an inclined surface 16a, 16b being inclined relative to the base 17a, 17b. The triangular shape may optionally have one right angle.

In the present embodiment, a prism element 6a is adapted to redirect light by TIR (such prism elements may also be referred to as TIR prism elements), as shown in FIG. 8. The angle α₂ of the inclined surface 16a relative to a base 17a of the prism element 6a is adapted such that the angle of incidence of the light relative to the inclined surface 16a is sufficiently high to obtain TIR at the inclined surface 16a. In the present example, wherein the prism element 6a is oriented such that the base 17a of the prism element 6a is (at least almost) perpendicular to the light beam obtained from the reflective surface (i.e. the base 17a of the prism element 6a is arranged parallel to the exit surface 6), the angle of incidence on the inclined surface 16a is the same as the angle α₂ of the inclined surface 16a relative to the base 17a.

Further, one or more prism elements 6b may be adapted to redirect light by refraction (such prism elements may also be referred to as refraction prism elements), as shown in FIG. 9. The angle α₂ of the inclined surface 16b relative to the base 17b of the prism element 6b is adapted such that the angle of incidence of the light relative to the inclined surface 16b is sufficiently low to obtain refraction (and not TIR) at the inclined surface 16a. In the present example, wherein the base 17b of the prism element 6b is (at least almost) perpendicular to the light reflected by the reflective surface, the angle of incidence is the same as the angle α₂ of an inclined surface 16b relative to a base 17b. The desired direction of the light output from the refraction prism element 6b is dependent on the refractive index of the refraction prism element 6b and may be calculated using Snell's law. A preferable angle α₂ of the inclined surface 16b relative to the incident light can be calculated from α₃=α₁−αa₂, wherein α₁ is the angle of the refracted light relative to a normal to the inclined surface 16b, α₃ is the desired angle of the refracted light relative to the incident light, and the relation between α₁ and α₂ is given by Snell's law. By increasing α₂, the refracted light forms a lower angle relative to the normal to the secondary surface (and the angle α₃ of the refracted light relative to the incident light increases). However, the angle of the redirected light relative to the secondary surface may not be less than 30 degrees, as a higher α₂ may result in the incident light being instead reflected at the inclined surface by TIR (as in the TIR prism element 6a). Hence, the refraction prism elements 6b may preferably cover the angular range of the light output approximately from 40 degrees to 75 degrees and the TIR prism elements 6a may cover the angular range of the light output approximately from 0 degrees to 40 degrees relative to the secondary surface.

According to an embodiment, the prism element 7 may have a curved (such as concave) inclined surface 8, at which TIR and/or refraction takes place, as shown in FIG. 10. The concave surface 8 increases the range of directions into which incident light is redirected by a single prism element 7. The present embodiment is advantageous in that the light distribution of the lighting device is more uniform.

Turning again to FIG. 6, a further embodiment of the present invention will be described. Phosphor (or any other type of wavelength converting material) may be arranged to convert at least a portion of the light emitted by the light source 3 into a different wavelength in order to obtain a particular color of the light output. For example, the LED die may be embedded in phosphor and/or a screen comprising phosphor may be arranged at the light source 3. However, using phosphor may result in a color gradient of the light projected onto the reflective surface 4 and subsequently onto the exit surface. Using for instance a yellow phosphor and a blue light source 3, light of lower correlated color temperature (CCT) may be projected onto the edges of the reflective surface 7. The rays with different CCT are oriented in substantially the same direction since they are collimated by the reflective surface, and are separated in position at the exit surface 5. In other words, the CCT varies over the exit surface 5 (i.e. with the position at the exit surface 5). The position of the prism elements 6 may preferably be selected so as to mix the light output. For example, one or more prism elements 6 may be located at a position of the exit surface 5 where light of higher CCT is projected, in order to redirect that light onto a region of the secondary surface where light of lower CCT is projected, thereby making the light output more uniform in terms of color.

According to an embodiment of the present invention, the lighting device 1 may preferably comprise two mirrored halves, i.e. two similarly configured halves for emitting light in two opposite main directions, as illustrated in FIG. 2. Hence, the lighting device may comprise two reflective surfaces 4, two exit surfaces 5, each having a set of prism elements 6 mounted thereto. Preferably, a single solid light transmissive body may form both the mirrored halves. Hence, the mirrored halves may intersect laterally at the centre of the body. Further, the same light source 3 may be utilized for illuminating both reflective surfaces 4 and may be arranged laterally at the centre of the body.

The lighting device 1 may be a linear lighting device, comprising a row of light sources 3 and an elongated optical structure 4. In that case, the prism elements 6 may extend in a longitudinal direction along the elongated optical structure 4 and have prism shaped cross-sections.

According to another embodiment (not shown), similar to the embodiment described with reference to FIG. 6, except that no prism elements are arranged at the exit surface, the curvature of the concave reflective surface itself is configured such that the intensity of the light reflected by the reflector increases with the angle of the direction of the light relative to a normal to the secondary surface from the first intensity value to the second intensity value.

According to an embodiment of the invention, the lighting device may be of linear type and emit at least 1800 lm per meter of the lighting device, which is advantageous in that such a relatively high light output reduces the number of lighting devices for illuminating a particular area.

While embodiments of the invention have been illustrated and described in detail in the drawings and foregoing description, such illustration and description are to be considered illustrative or exemplary and not restrictive; the invention is not limited to the disclosed embodiments. It will be appreciated that the illustrations in the drawings may not be according to scale, in particular not the first distance relative to the second distance, which have been adjusted in the drawings in order to clearly illustrate both the lighting device and its illumination area in the same figure. Further, the size of the illumination area relative to the size of the lighting device have been adjusted in the drawings in order to clearly illustrate both the lighting device and its illumination area in the same figure.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A lighting device for illuminating a secondary surface, thereby providing indirect illumination via reflection from the illuminated secondary surface, the lighting device being adapted to be mounted at a first distance (d₁) from the secondary surface such that the redirected light impinges at the secondary surface up to a second distance (d₂) along the secondary surface from the lighting device, the ratio of the second distance to the first distance being at least 5, the lighting device comprising:
a light source,
a collimator arranged to collimate light from the light source, and
redirecting means arranged to redirect at least a portion of the collimated light into a range of directions towards the secondary surface, the range of directions being bounded by a first direction (131) that makes a minimum angle relative to a normal to the secondary surface (200), and a second direction (132) that makes a maximum angle relative to a normal to the secondary surface (200), the minimum angle being lower than 30 degrees and the maximum angle being approximately tan⁻¹(d₂/d₁),
wherein the light source, the collimator and the redirecting means are arranged such that from the first direction to the second direction the intensity of the redirected light increases from a first intensity value to a second intensity value,
the ratio of the second intensity value to the first intensity value is between 25 and 400, and wherein the light source, the collimator and the redirecting means are arranged such that at least 50% of the luminous flux of the redirected light originates from directions forming an angle exceeding a halfway angle relative to the normal to the secondary surface, the halfway angle being approximately tan⁻¹(d₂/2d).

2. The lighting device as defined in claim 1, wherein the degree of collimation provided by the collimator in combination with the beam shaping characteristics of the redirecting means is configured such that the intensity of the redirected light increases with the angle of the direction of the redirected light relative to the normal to the secondary surface from the first intensity value to the second intensity value.

3-7. (canceled)

8. The lighting device as defined in claim 1, wherein the redirecting means comprises a specular reflective surface.

9. The lighting device as defined in claim 1, wherein the light source is a linear light source and the redirecting means presents an elongated body whose longitudinal direction extends along the longitudinal direction of the linear light source.

10. The lighting device as defined in claim 1, wherein the redirecting means has an annular shape and one or more light sources and one or more collimators are arranged at a center portion of the annular shape.

11. The lighting device as defined in claim 1, wherein the light source and the collimator are arranged such that the average direction of the light collimated by the collimator is directed along the secondary surface, and wherein the redirecting means comprise a convex reflective surface being arranged to face the collimator and the secondary surface.

12. The lighting device as defined in claim 11, wherein the light source, the collimator and the reflective surface are arranged such that the intensity of light redirected by the reflective surface decreases for an increase of the angle (α) of the direction of the redirected light relative to the reflective surface from the second intensity value to the first intensity value.

13. The lighting device as defined in claim 11, wherein the light source comprises a plurality of light emitting elements arranged in groups, wherein the groups are arranged to illuminate different portions of the reflective surface via the collimator and are individually controllable with respect to light intensity.

14. The lighting device as defined in claim 1, wherein the light source and the collimator are arranged such that the average direction of the light collimated by the collimator is directed transverse to the secondary surface, wherein the redirecting means comprises a concave reflective surface arranged to face away from the secondary surface.

15. The lighting device as defined in claim 14, wherein the redirecting means further comprises a plurality of prism elements for redirecting light from the reflective surface by means of total internal reflection and/or refraction.
